(19) United States
(12) Patent Application Publication
(10) Pub. No.: US 2025/0379281 A1
(43) Pub. Date: Dec. 11, 2025

(54) Underground battery storage

(71) Applicant: Yue Fan, Seattle, WA (US)

(72) Inventor: Yue Fan, Seattle, WA (US)

(21) Appl. No.: 18/831,457

(22) Filed: Jan. 25, 2025

Related U.S. Application Data
(60) Provisional application No. 63/630,386, filed on Jan. 26, 2024.

(51) Int. Cl. H01M 10/6551; H01M 10/42; H01M 10/613; H01M 10/627; H01M 10/656; H01M 50/204; H01M 50/24; H01M 50/251; H01M 50/691

(52) U.S. Cl. CPC H01M 10/6551; H01M 10/425; H01M 10/613; H01M 10/627; H01M 10/656; H01M 50/204; H01M 50/24; H01M 50/251; H01M 50/691; H01M 2010/4271; H01M 2220/10

(57) ABSTRACT

A method and system for an underground energy storage system.

### BACKGROUND

### Field of the Invention

An underground energy storage system having an overall elongated profile allows for easy underground installation and reduced thermal conditioning.

### Description of the Related Art

High capacity energy storage systems (ESS), such as battery energy storage systems (BESS) are presently installed above ground, which uses valuable above ground land area and is unsightly. Moreover, above-ground environments may have large temperature fluctuations that require extensive thermal conditioning systems, and require mechanical protection from accidental or deliberate damage.

### SUMMARY

In one embodiment of the invention, an at least one battery energy storage system (BESS) is packaged in a long cylinder form factor. Battery cells contained is adaptable to type needed for application including Nickel Cobalt Manganese, Lithium Iron Phosphate, Lithium Titanate, Sodium ion, lead acid, Nickel metal hydrate, Nickel cadmium, carbon zinc, and others. Battery cells are directly thermally interfaced to the wall(s) of the cylinder via direct contact, with thermal interface materials and/or static mechanical interfaces.

In another embodiment of the invention, an at least one battery energy storage system (BESS) is packaged in a long cylinder form factor. Battery cells contained is adaptable to type needed for application including Nickel Cobalt Manganese, Lithium Iron Phosphate, Lithium Titanate, Sodium ion, lead acid, Nickel metal hydrate, Nickel cadmium, carbon zinc, and others. Battery cells are indirectly thermally interfaced to the wall(s) of the cylinder, via cooling loops, airgap or air flow, Peltier-effect type devices, thermally-expanding materials, or external cooling interfaces.

In another embodiment of the invention, an at least one battery energy storage system (BESS) is packaged in a long cylinder form factor. Additionally power electronics are packaged into the cylinder to interface with external energy sources or with a load, and may be an inverter, converter, PWM driver, or other electronics.

In another embodiment of the invention, an at least one battery energy storage system (BESS) battery cells and supporting components are packaged in a long cylinder form factor. Additionally power electronics are packaged in a separate cylinder to interface with other energy sources or with a load, and may be an inverter, converter, PWM driver, or other electronics. Waterproof interconnects are used between the battery and power electronics cylinders.

In another embodiment of the invention, an at least one battery energy storage system (BESS) battery cells and supporting components are packaged in a short cylinder form factor. Multiple short cylinders can mechanically and electrically interconnect with each other in an axial direction to facilitate vertical installation one short cylinder at a time using an associated tool to alternately hold and lower the existing top-most short cylinder and a new top-most short cylinder.

In another embodiment of the invention, an at least one battery energy storage system (BESS) is packaged in a long hollow rectangular extrusion form factor. Battery cells contained is adaptable to type needed for application including Nickel Cobalt Manganese, Lithium Iron Phosphate, Lithium Titanate, Sodium ion, lead acid, Nickel metal hydrate, Nickel cadmium, carbon zinc, and others. Battery cells are directly thermally interfaced to the wall(s) of the extrusion via direct contact, with thermal interface materials and/or static mechanical interfaces.

In another embodiment of the invention, a structural container that is sealed against underground moisture intrusion houses battery cells, and/or battery modules, and/or battery controls, and/or power electronics such that access to remove, install, or inspect said components is possible from the top or from the side using rails or stairs features.

### BRIEF DESCRIPTION OF THE DRAWINGS

FIGS. 1a-1c show a battery energy storage system (BESS) in a cylindrical layout (installed cross section, detailed cross section, and isometric, respectively), its major components, thermal interfaces, electrical interfaces, and environmental protection suitable for underground use. Thermal energy is transferred from battery cell to cylindrical outer profile directly.

FIGS. 2a-2b show two thermal interface variants of a battery energy storage system (BESS) in a cylindrical layout, its major components, thermal interfaces, electrical interfaces, and environmental protection suitable for underground use. Thermal energy is transferred from battery cell to cylindrical outer profile indirectly.

FIG. 3 shows a battery energy storage system (BESS) in a cylindrical layout, having battery cells and power electronics.

FIG. 4 shows a battery energy storage system (BESS) in a cylindrical layout with battery cells and power electronics in separate cylinders.

FIGS. 5a-5b show a battery energy storage system (BESS) in a cylindrical layout with multiple cylinders connected together axially, and installation tool without and with the ability to temporarily securing cylinders, respectively.

FIGS. 6a-6c show a battery energy storage system (BESS) in a rectangular layout (installed cross section, detailed cross section, and isometric, respectively), its major components, thermal interfaces, electrical interfaces, and environmental protection suitable for underground use.

FIGS. 7a-7b show a structural container located underground which houses a battery energy storage system (BESS) and structures which enable access for service and installation using access covers and stairs, respectively.

FIG. 8 shows a cross section view of an underground battery system having distributed components (switchgear) across multiple underground cylinders.

### DETAILED DESCRIPTION

One of ordinary skill in the art will appreciate that the embodiments presented serve as non-limiting examples, and that the novel and non-obvious teachings presented enable the creation of additional variations specific to their implementations.

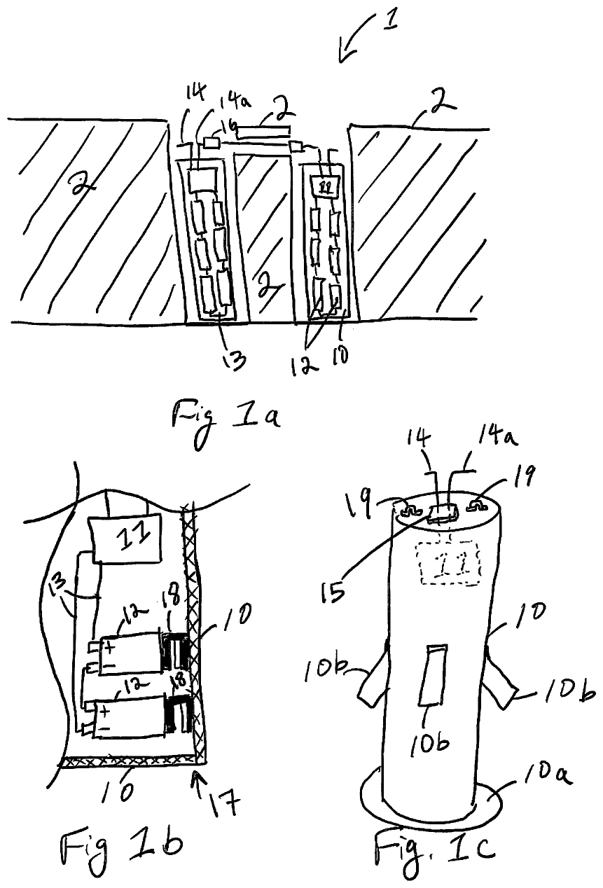

In an exemplary embodiment of the invention, referring to FIG. 1a, cylindrical form BESS 10 is installed into ground 2. A multitude of cylinders 10 are interconnected via connections 14 and 14a which are going to loads or upstream BESS and downstream BESS, respectively. Connection blocks 16 create sealed connections that can be made after cylinder 10 is installed in ground 2. Cylinder 10 contains battery cells 12 which are connected electrically via conductors 13 which may be flexible cables, busbars, or direct connections between cells. Now referring to FIG. 1b in section view, cells 12 are thermally connected to cylinder 10 for thermal transfer to ground 2 using thermal shims 18. Thermal shims 18 may be attached to cells 12 and cylinder 10 via thermally conductive adhesives, mechanical tension, or fasteners. Thermal shims 18 may be adjusted in geometry in order to balance thermal transfer efficiency and shim size. Still referring to FIG. 1b, a disconnect unit 11 connects and disconnects battery energy from the rest of the cylinder 10. Mechanical joint 17 may be created in cylinder 10 using laser welding, sonic welding, adhesives, stir welding, brazing, soldering, or other sealing methods. Cylinder 10 may be made of metals such as stainless steel, steel, iron, aluminum, titanium, alloys of metals, polymers, glass filled polymers, other plastics, nylons, and other suitable materials for environmental sealing. Additional structures may aid cylinder 10 in supporting internal and external mechanical loads. Now referring to FIG. 1c in perspective view, electrical connections are made outside of connection 10 via a sealed passthrough 15 which may be mechanically sealed to cylinder 10 via adhesives, seals, soldering, or other means, and passthrough 15 may be made of conductors such as stainless steel or insulators such as ceramics so that electrical connections 14 and 14a may pass through without leak paths to the inside of cylinder 10. Lift features 19 aid in lifting cylinder 10 into and out of ground 2 and are engineered to withstand both gravitational force on cylinder 10 and friction between cylinder 10 and ground 2, as well as forces imposed by mechanical stabilizers 10a and 10b. Stabilizers 10a and 10b restrict movement and settling of cylinder 10 in soft and moving grounds.

Stabilizer 10b may be statically attached or deployed via external controls. Similarly, stabilizer 10a may be folded or rotated to a smaller and lower resistance to movement profile until the desired depth is reached. Attachment point 19 may also serve as electrical grounding in applications where necessary. Cylinder wall thickness is determined using FEA or Euler's Critical Load equations as follows:

$${P}_{cr} = \frac{{π}^{2} EI}{{\{ KL \}}^{2}}$$

where
P_{cr}, Euler's critical load (longitudinal compression load on column),
E, Young's modulus of the column material,
I, second moment of area of the cross section of the column (area moment of inertia),
L, unsupported length of column,
K, column effective length factor

The cylinders 10 may be pressurized using an internal pump, a chemical gas generator, heater, or the like, or may be pressurized and sealed during manufacturing in order to increase load capacity and reduce the risk of buckling under load.

In another embodiment shown in FIG. 2a in section view, thermal transfer between the cells 12 and cylinder 10 is accomplished via heatsinks 20a and 21a, having coolant flow via tubes 25 sourced from reservoir 23 and circulated by pump 22. Coolant flow may be in series or in parallel to a multitude of heatsinks 20a and may be optimized such that. each cell 12 is cooled substantially the same amount even with differences in hydraulic head height and distance from pump 22, as can be appreciated by one of ordinary skill in the art. Heatsinks 20a and 21a may be shaped to conform to the surfaces they are transferring heat to and from, and may be aided by thermal interface materials. Additionally heating may be incorporated into the cooling loop or directly to battery cells 12 via electrical heaters such as resistive coils, PTC elements, film heaters, or the like. Now referring to FIG. 2b in section view, Peltier (thermoelectric Seabeck Effect) devices are used transfer heat to and from cells 12 and cylinder 10 using current source 24 connected using electrical connections 26. Both cooling systems described in FIGS. 2a and 2b may be controlled via controllers to maintain desired temperatures for desired modes of operation or in anticipation of certain modes of operation at a future time, as can be appreciated by one of ordinary skill in the art. Additionally instantaneous and future temperatures of ground 2 may be utilized in controlling the heating and cooling operation in order to minimize energy use. Energy used may be sourced from external power sources or from internal battery cells 12 and conversion or control equipment.

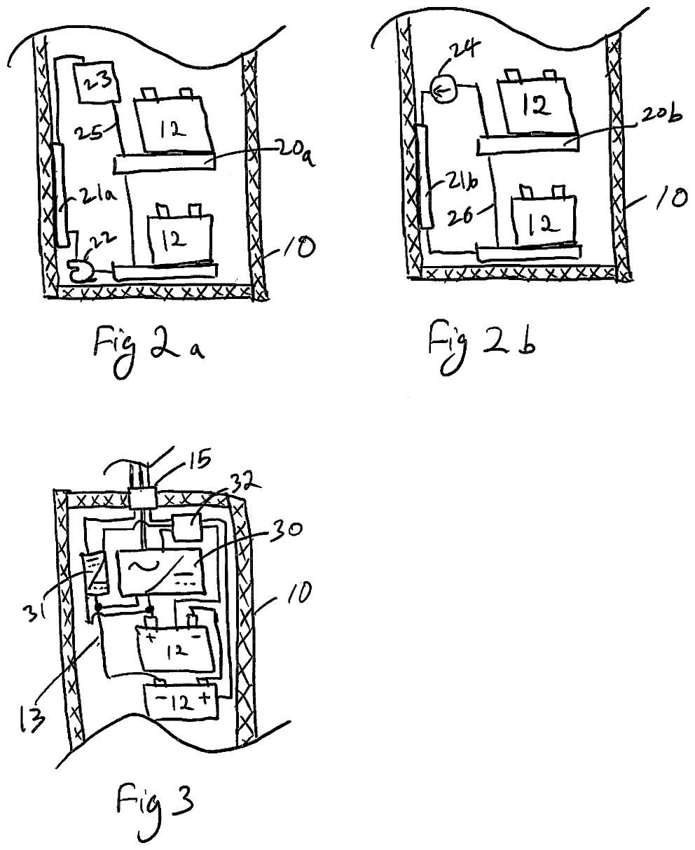

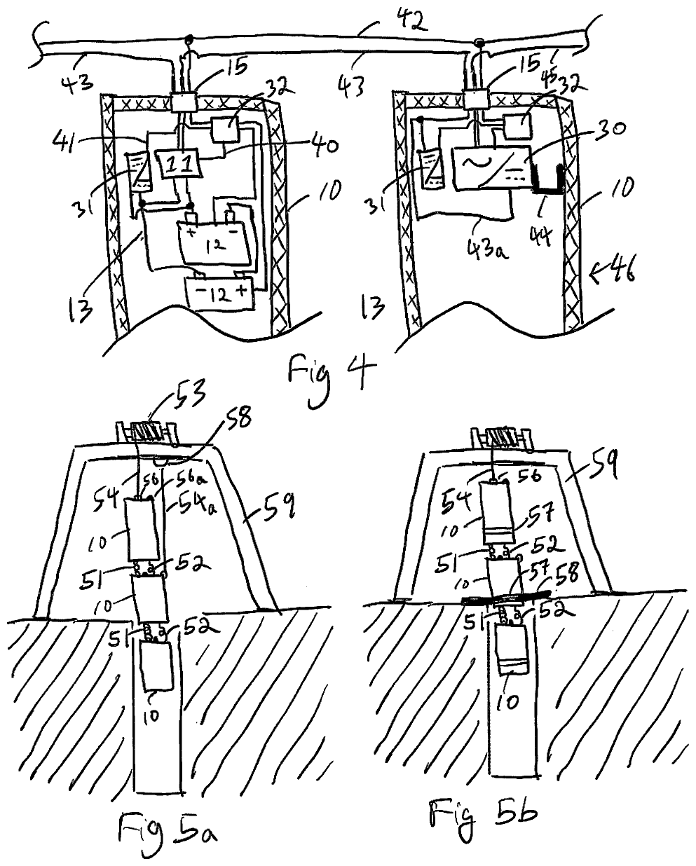

In another embodiment shown in FIG. 3 in section view, power electronics are integrated into cylinder 10. Inverter 30 provides AC power output (such as single phase, 3 phase wye, 3 phase delta, etc.) and may be synchronized to a grid or microgrid via internal controls such as BMS 32 or via an external control. Inverter 30 can also operate DC-DC converter 31 provides power to internal loads such as pump 22 or current source 24, as well as BMS 32 and inverter 30. It can also power external loads via passthrough 15. Energy is sourced and sunk into battery cells 12. Components such as inverter 30, DC-DC converter 31, and BMS 32 may be cooled via the same cooling methods of FIGS. 2a and 2b or may directly conduct heat to cylinder 10 as shown in FIG. 1b. BMS 32 collects and processes battery cell voltage, temperature, and current telemetry in order to set charge and discharge limits, as well as predict available energy and power.

In another embodiment shown in FIG. 4 in section view, multiple cylinders 10 are interconnected and contain differing components. Cylinder 10 on the left hand side contain battery cells 12, which are monitored by BMS 32 which also controls disconnect unit 11. Auxiliary power for powering components within cylinders 10 are provided by DC-DC converters 31. Electrical connections 13, 40, and 41 carry internal DC, controls, and converted DC, respectively. In the right hand side cylinder 10 which is functionally inverter cylinder 46, DC power 43 from left hand side cylinder 10 is inverted by inverter 30 via internal bussing 43a to provide AC power (such as single phase, 3 phase wye, 3 phase delta, etc.) to external loads via electrical bussing 45. Passthroughs 15 facilitate connections that are water tight. Controls such as system startup, safety checks, load anticipation, thermal conditioning, state of charge control, etc. are coordinated via communication bus 42 which may be LIN, CAN, SPI, ISO-SPI, FlexRay, Ethernet, PWM, discrete signals, wireless signals including Wi-Fi 802.11x, SSB, and the like. Wireless signals may be broadcast and received with antenna elements, where the ground plane may be formed by the main structure of cylinder 10 and additional antenna elements by galvanically isolated panels such as on such as on or embedded inside passthrough 15, or residing inside cylinder 10 and utilizing passthrough 15 or the like as an RF aperture. DC-DC converter 31 may be incorporated to provide low voltage DC for controls and standby loads used by inverter 30 and BMS 32. Thermal conditioning of electronics may be performed using thermal conductor 44 between inverter 30 and cylinder 10, or indirect thermal conduction may be incorporated using heatsinks or Peltier devices of FIGS. 2a and 2b, respectively.

In another embodiment shown in FIG. 5a, multiple smaller cylinders are used to achieve underground electrical energy storage and/or conversion. Cylinders 10 are joined by load bearing links 51 and electrical links 52, via attachment points 56. During installation or removal, lift tool 59 using wench 53 or the like lifts or lowers the multitude of conjoined cylinders 10 using cable 54 connected to lift point 56. Additional lift points 56a and additional cable 54a are used to statically hold cylinders 10 while the top most cylinder 10 is installed or removed from the axial chain of cylinders 10. FIG. 5b shows an alternative implementation of temporarily securing cylinders 10 while adding or removing the top most cylinder 10 from the axial chain of cylinders 10, via positive stop features 57 and holding plate 58 which engages with the ground and positive stop features 57.

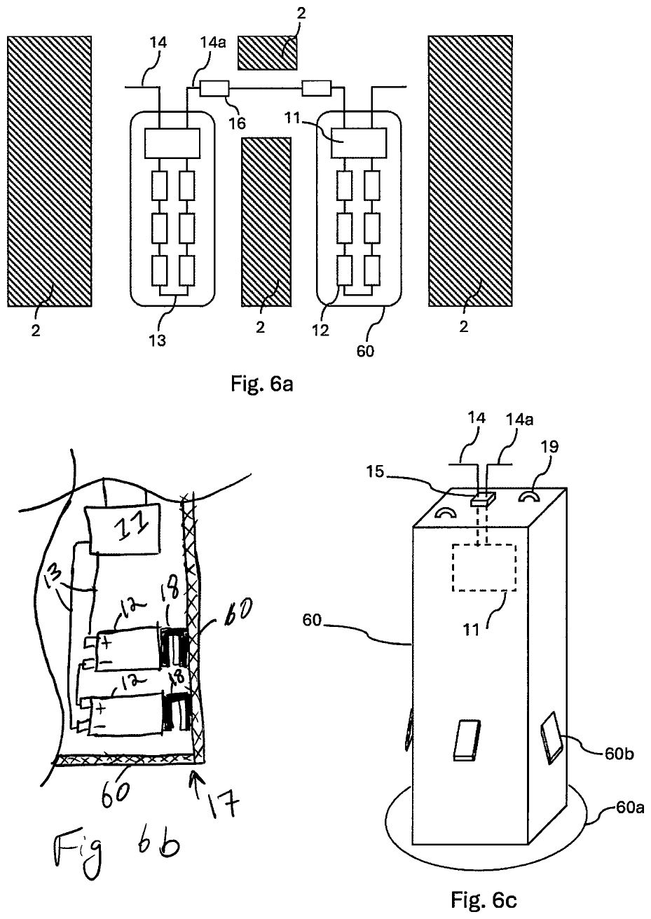

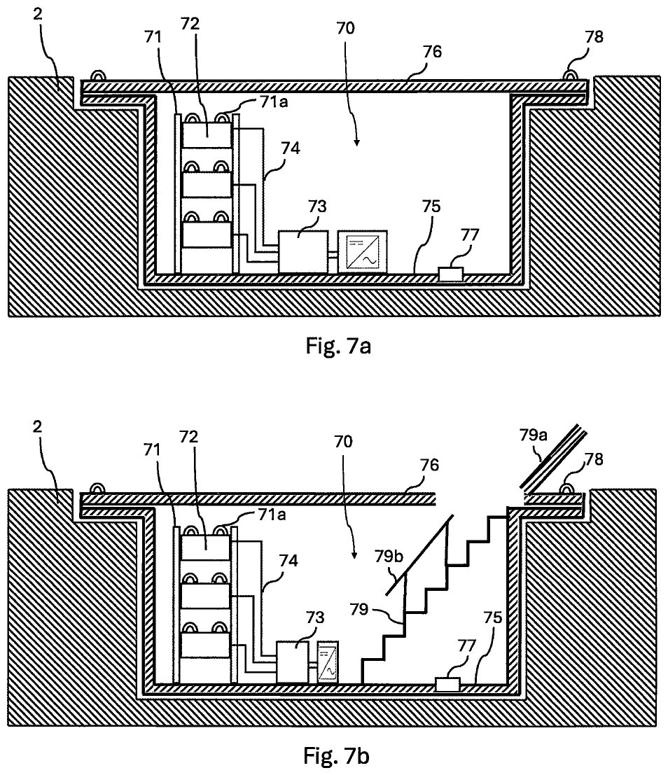

In another embodiment shown in FIGS. 6a through 6c, a rectangular profile variant of FIGS. 1a-1c provides similar functionality while reducing the complexity of thermal shims 18. One of ordinary skill in the art can appreciate other profile differences which can be implemented to suit unique applications and internal components.

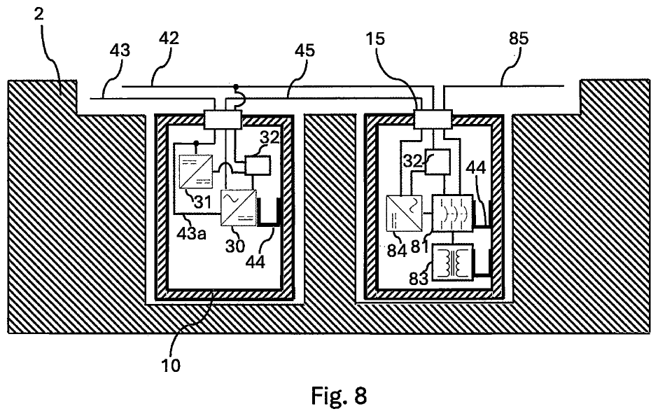

In another embodiment shown in FIG. 7a, a rectangular underground housing 75, contains battery modules 72 which can be installed or removed through the opening created by removing lid 76. Railings 71 and lift points 71a enable removal of battery modules 72. Battery modules 72 are electrically connected via bussing 74 to a junction box 73 where electrical energy can be transferred with loads through a converter or inverter, or directly with outside loads via a passthrough. Lid 76 may be aided in removal by lift points 78 which can fold flush into lid 76 or be removable. Lid 76 may seal against housing 75 via gaskets, sealants, or a bilge pump may be incorporated. Drain 77 allows condensation or small leaks to drain into ground 2. Alternatively FIG. 7b shows a container 75 having a top access cover 79a which exposes stairs 79 having railing 79b. An operator is able to climb down stairs 79 in order to service or configure battery modules 72 which are secured via railings 71. Drain 77 provides condensation or small leaks a path to the ground which housing 75 sits in. The top side of housing 75 is not shown for illustrative clarity purposes.

In another embodiment shown in FIG. 8 in cross sectional view, switchgear cylinder 80 formed externally by cylinder 10 is connected to inverter cylinder 46 via communication bus 42 and electrical bussing 45 to transform AC voltage to levels needed by loads connected via one or more load bus(es) 85. Low voltage supply 84 powers switchgear controller 82 control a multitude of switches and breakers 81 and also monitor transformer block 83 which may have multiple taps or be comprised of multiple independent transformers. Thermal shims 44 conduct heat to the casing of cylinder 10, though indirect or phase change thermal conduction may be incorporated in cases where skin effect, eddy current, hysteresis, or other losses require additional cooling with respect to ambient ground conditions as understood by one of ordinary skill in the art.

1. An energy storage system that resides underground having battery cells, and/or electronics, and/or switchgear which are protected from moisture, thermal, and/or mechanical loads.

2. The system of claim 1 where a cylindrical housing provides environmental protection and thermal dissipation, and may contain additional trusses or beams to increase mechanical strength.

3. The system of claim 1 where a multi-faceted housing with internal volume provides environmental protection and thermal dissipation.

4. The system of claim 1 where a housing containing components of the energy storage system is metal and sealed using welding, soldering, adhesive and adhesive strips, viscous grease, polymers, binders, interference fits including shrink fitting and tapered threads with or without tape or dope, or gaskets, and may contain moisture-absorbing materials.

5. The system of claim 1 where a housing containing components of the energy storage system is pressurized via internal gas pressure generation or pressurized during manufacturing to increase compressive load strength.

6. The system of claim 1 where a housing containing components of the energy storage system has wall(s) between 0.5 mm and 5 mm in thickness.

7. The system of claim 1 where the battery cells are lithium-nickel based or lithium-iron phosphate based or lithium-titanate based or sodium based.

8. The system of claim 1 where water tight interconnects are made of conductors passing through and sealed to a block of glass, ceramics, polymers, or metal treated to be electrically insulating.

9. The system of claim 1 where stabilizing mechanical features or protrusions maintain the system at a predetermined location in the ground, where the features or protrusions may be in fixed positions or have variable geometry to allow freedom of movement during installation prior to a final position.

10. The system of claim 1 where internal thermal dissipation to an external surface of the energy storage system is performed via thermally conductive shims and brackets, performed using liquid cooling via heatsinks optionally including a pump and radiators, via submersion in a liquid, via Peltier devices, via phase change devices optionally including compressors and refrigerants, or via air circulation optionally including fan(s).

11. The system of claim 1 where power electronics such as inverters and converters, transformers, controllers, switches such as relays or contactors are included in order to power or recharge from external loads and sources using AC or DC electricity.

12. The system of claim 1 where an AC power bus, and/or a DC power bus, and/or a communication bus allow separately housed components of the system to function together or provide redundancy, where the communication bus may be wireless with one or more galvanically isolated RF elements or apertures.

13. The system of claim 1 where separately housed components of the system provide redundant power, communication, or cooling for the system.

14. The system of claim 11 where separate housings are interconnected mechanically in an axial direction to allow additional housings to be added as the system is lowered into the ground.

15. The system of claim 1 where the system is housed in an underground housing having an at least one access panel and system components attached to rails such that components of the system can be removed via the access panel without removing the housing in its entirety from the ground.

16. The system of claim 15 where a drain system removes accumulated condensation from inside the housing.

17. A method of storing energy that resides underground using battery cells, and/or electronics, and/or switchgear which are protected from moisture, thermal, and/or mechanical loads.

18. The method of claim 17 utilizing a cylindrical housing to provide environmental protection and thermal dissipation, and may contain additional trusses or beams to. increase mechanical strength.

19. The method of claim 17 utilizing a multi-faceted housing with internal volume to provide environmental protection and thermal dissipation.

20. The method of claim 17 utilizing a housing containing components of the energy storage system is constructed using metal and sealed using welding, soldering, adhesive and adhesive strips, viscous grease, polymers, binders, interference fits including shrink fitting and tapered threads with or without tape or dope, or gaskets, and may contain moisture-absorbing materials.
